(19) United States
(12) Patent Application Publication
(10) Pub. No.: US 2013/0270885 A1
(43) Pub. Date: Oct. 17, 2013

(54) HEAD RESTRAINT POSITION ADJUSTING DEVICE AND HEAD RESTRAINT POSITION ADJUSTING METHOD

(71) Applicant: FUJIKURA LTD., Tokyo (JP)

(72) Inventor: Yuichiro Yamaguchi, Sakura-shi (JP)

(21) Appl. No.: 13/917,110

(22) Filed: Jun. 13, 2013

Related U.S. Application Data
(63) Continuation of application No. 12/597,141, filed on Jan. 12, 2010, now abandoned.

(30) Foreign Application Priority Data
Apr. 24, 2007 (JP) 2007-113821
Dec. 25, 2007 (JP) 2007-331510

(51) Int. Cl. B60N 2/48

(52) U.S. Cl. CPC B60N 2/4805
USPC 297/391

(57) ABSTRACT

A head rest position adjusting device 100 has a capacitance sensor unit 10 and a drive motor unit 30, and the capacitance sensor unit 10 has plural detection electrodes 11 to 15. Each detection electrode 11 to 15 are formed in a rectangular strip having a long side arranged in a width direction intersecting with a height direction of a head restraint 43 at the front face side thereof, and are arranged in such a way that the long sides are aligned along the height direction. A detection circuit 20 has plural capacitance detection circuits 21 to 25 connected to the detection electrodes 11 to 15, respectively, and an arithmetic processing circuit 28, and the drive motor unit 30 has a motor drive circuit and a drive motor. Even if the head restraint 43 is in an initial condition, the detection circuit 20 detects an estimated center position of a head 49 in the height direction or a detection electrode having the highest output as a reference position from detection signals from individual detection electrodes 11 to 15, and adjusts a position of the head restraint 43 relative to a seat 40 with reference to the reference position.

### CROSS-REFERENCE TO RELATED APPLICATIONS

This is a continuation application of U.S. patent application Ser. No. 12/597,141, filed on Jan. 12, 2010, which is a 371 of International Application No. PCT/JP2008/057902, filed on Apr. 24, 2008, which claims the benefit of priority from the prior Japanese Patent Application Nos. 2007-113821, filed on Apr. 24, 2007 and 2007-331510 filed on Dec. 25, 2007, the entire contents of which are incorporated herein by references.

### TECHNICAL FIELD

The present invention relates to a head restraint position adjusting device and a head restraint position adjusting method which adjust a position of a head restraint attached to a seat of a vehicle like an automobile, and more specifically, a head restraint position adjusting device and a head restraint position adjusting method which automatically adjust a position of the head restraint to a comfortable position.

### BACKGROUND ART

Conventionally, there are devices which adjust a position of a head restraint attached to a seat of a vehicle like an automobile. That is, patent literature 1 discloses a vehicular head restraint device that comprises an ECU which compares an amount of change in a capacitance detected by a capacitance sensor with a threshold set beforehand when a front portion of a head restraint is moved in a direction of fully-open position, and which determines that the front portion of the head restraint is moved closer to a head of a driver/passenger (human body) when the amount of change is greater than the threshold.

The ECU detects a change in capacitance per unit displacement of the capacitance sensor at a predetermined timing, changes the threshold based on a detection result, changes the threshold at a regular time interval, or changes the threshold based on a drive voltage for a motor. Accordingly, the ECU precisely detect that the front portion of the head restraint is moved close to the head of the driver/passenger.

Patent literature 2 discloses a device for adjusting a head restraint. Such a device comprises a sensor including two capacitor plates which are for detecting a position of a head of a driver/passenger, and which are arranged inside the head restraint. The two capacitor plates are arranged in the vertical direction inside the head restraint.

As far as a sensor signal (detection signal) from one capacitor plate increases while at the same a sensor signal from another capacitor plate decreases, a position of the head restraint in height is adjusted in such a manner as to be changed from a home position where the head restraint is retracted.

Patent literature 3 discloses a head restraint driving device that comprises support means for movably supporting a head restraint, drive means for reciprocatingly driving the head restraint, plural detection electrodes which are spaced apart one another inside a portion of an external cover of the head restraint supporting a head, capacitance detection means for detecting a capacitance formed by the plural detection electrodes relative to a common potential line, and position control means for controlling the drive means to move the head restraint in a direction in which the capacitance is balanced.

The head restraint is driven in such a way that the head is located at a center of the plural detection electrodes, in other words, the head restraint is moved in accordance with a motion of the head, and then a position of the head restraint is automatically adjusted.

Patent literature 4 discloses a head restraint adjusting device that comprises a head restraint movable in the vertical direction by a motor and arranged on the top of a seat back (backrest), a head detection sensor which detects a position of a head of a user (driver/passenger) sitting down a seat, and a CPU which adjust a height of the head restraint in accordance with a position of the head of the user sitting down the seat based on a signal from the head detection sensor.

When the CPU detects that an ignition switch is turned on, a seating detection sensor detects that the user is seated, and a seatbelt buckle switch detects that a seat belt is fastened, an operation of adjusting the head restraint is started.

Patent Literature 1: JP2007-30676A

Patent Literature 2: JP2000-309242A

Patent Literature 3: JPS64-11512A

Patent Literature 4: JPH11-180200A

### DISCLOSURE OF INVENTION

### Problem to be Solved by the Invention

According to the vehicular head restraint device disclosed in patent literature 1 or the device for adjusting the head restraint disclosed in patent literature 2, however, a capacitance between the head and the detection electrode is measured and the measurement result is used for adjusting the position using one capacitance sensor in the case of the former device and two or three capacitor plates in the case of the latter device.

According to the head restraint driving device disclosed in patent literature 3 or the head restraint adjusting device disclosed in patent literature 4, the position of the head restraint is adjusted based on a capacitance between the head restraint and a roof or the like of the vehicle in the case of the former device, and based on an adjustment result of each part of the seat in the case of the latter device.

Accordingly, it is necessary to detect a center of the head while comparing an output balance of a sensor and an output peak of each detection electrode. This kind of detection fashion requires a detection operation of moving the head restraint having the detection electrode thereinside from bottom to top in the height direction to scan such a movement, and of specifying a position where an output of the sensor is balanced or of detecting an output peak of each detection electrode. Therefore, it is difficult to carry out position adjustment highly precisely within a short time.

In particular, according to the foregoing detection fashion, it is not considered that a factor other than a shape of the head may cause an output fluctuation as the head moves while the position thereof is being detected. Accordingly, it takes a certain amount of adjustment time to carry out position adjustment highly precisely, so that position adjustment cannot be carried out within a short time.

As an example, FIG. 13 shows a detection result of a sensor output in a test carried out by the applicant of the present invention when a head restraint was provided with a capacitance sensor with a user being sitting down a seat. In FIG. 13, tests were carried out for three kinds of head restraint having a detection electrode at a bottom portion, a center, and an upper portion, respectively. Note that the vertical axis in FIG. 13 represents a distance (height of sensor) from a center of the detection electrode to a top of the seat, while the horizontal axis represents a sensor output at each detection position. A distance between the head of the user and the head restraint was maintained to 20 mm, and the tests were carried out while the user came to rest as much as possible.

As a result, as is clear from FIG. 13, a sensor output hardly became stabilized, and it can be expected that an output has a further unstable behavior in a riding condition at a normal time. Based on the test results, it becomes clear that adjusting a position of the head restraint highly precisely by carrying out the detection operation in the foregoing detection fashion requires an adjustment time, and is difficult to carry out.

The present invention has been made in view of the foregoing circumstance, and it is an object of the present invention to provide a head restraint position adjusting device and a head restraint position adjusting method which can automatically adjust a position of a head restraint highly precisely within a short time.

### Means for Solving the Problem

A head restraint position adjusting device according to an aspect of the present invention comprises: a plurality of detection electrodes arranged side by side in a line along a height direction of a head restraint attached to a seat of a vehicle, and each configured to detect a capacitance between a head of a human body sitting down the seat and the head restraint; a detection circuit configured to detect a reference position of the head in the height direction based on detection signals from the plurality of respective detection electrodes; and position adjusting means for adjusting a position of the head restraint relative to the seat with reference to the reference position of the head in the height direction in accordance with a detection result of the detection circuit, and the plurality of detection electrodes being provided by what corresponds to a number required for detecting the reference position of the head in the height direction with the head restraint being at a standstill.

The head restraint position adjusting device of the present invention having the foregoing configuration can automatically and appropriately adjust a position of the head restraint relative to the seat with reference to the reference position of the head in the height direction. Accordingly, it is possible to adjust a position of the head restraint highly precisely within a short time. Moreover, because a position of the head restraint relative to the seat is automatically adjusted, it is possible to suppress any accident like cervical spine injury of a driver/passenger when the vehicle collides under a condition in which a position of the head restraint is not adjusted.

The detection circuit may detect, for example, an estimated center position of the head in the height direction as the reference position, and the position adjusting means may adjust a position of the head restraint relative to the seat with reference to the estimated center position of the head in the height direction. This enables appropriate and automatic adjustment of a position of the head restraint relative to the seat with reference to the estimated center position of the head in the height direction.

The detection circuit may detect, as the reference position, the detection electrode having a detection signal with the highest output among the plurality of detection electrodes, and the position adjusting means may adjust a position of the head restraint relative to the seat so that the detection electrode having the detection signal with the highest output and detected by the detection circuit is located above a center position of the head restraint in the height direction. This enables appropriate and automatic adjustment of a position of the head restraint relative to the seat so that the detected detection electrode having the detection signal with the highest output is located above the center position of the head restraint in the height direction.

The plurality of detection electrodes may be each formed in a rectangular strip having a long side arranged in a width direction intersecting with the height direction of the head restraint at a front face side of the head restraint.

The plurality of detection electrodes may be arranged across the entire area of the head restraint in the height direction at an equal interval.

The plurality of detection electrodes may be arranged in the height direction of the head restraint at an equal interval for example, and a detection electrode group comprised of the plurality of detection electrodes may be so arranged as to be shifted as a whole in the height direction so that the detection electrode arranged in the vicinity of a center of the detection electrode group in the height direction is detected by the detection circuit as the detection electrode having a detection signal with the highest output.

The plurality of detection electrodes may be each formed in a rectangular strip having a long side in a width direction intersecting with the height direction of the head restraint along a front face thereof, and are arranged on the front face side of the head restraint.

At least five detection electrodes may be provided on a front face side of the head restraint.

The detection circuit may comprise: a plurality of capacitance detection circuits connected to the plurality of respective detection electrodes one by one, and each configured to output information indicating a capacitance detected by each detection electrode; and an arithmetic processing circuit configured to compare values of capacitances based on plural pieces of information from the plurality of respective capacitance detection circuits, calculate the reference position or detect the detection electrode having the largest detected capacitance, and output drive information for the head restraint to the position adjusting means in accordance with calculation result information or a detection result.

For example, the detection circuit may comprise: a time-sharing circuit connected to the plurality of detection electrodes; a capacitance detection circuit configured to output information indicating a capacitance detected by each of the plurality of detection electrodes through the time-sharing circuit in a different time; and an arithmetic processing circuit configured to compare values of capacitance based on plural pieces of information from the capacitance detection circuit, calculate the reference position or detect the detection electrode having the largest detected capacitance, and output drive information for the head restraint to the position adjusting means in accordance with calculation result information or a detection result.

A head restraint position adjusting method according to another aspect of the present invention comprises: detecting a capacitance between a head of a human body sitting down a seat of a vehicle and a head restraint attached to the seat through a plurality of detection electrodes arranged side by side in a line in the head restraint along a height direction of the head restraint, the plurality of detection electrodes being provided by what corresponds to a number required for detecting a reference position of the head of the human body sitting down the seat in the height direction with the head restraint being at a standstill; detecting the reference position of the head in the height direction based on detection signals each indicating a detected capacitance and output by each of the plurality of detection electrodes; and adjusting a position of the head restraint relative to the seat with reference to the detected reference position of the head in the height direction.

The head restraint position adjusting device of the present invention having the foregoing configuration can automatically and appropriately adjust a position of the head restraint from a standstill condition relative to the seat with reference to the reference position of the head in the height direction, thereby adjusting a position of the head restraint highly precisely within a short time. Moreover, because a position of the head restraint relative to the seat is automatically adjusted, it is possible to suppress any accident like cervical spine injury of a driver/passenger when the vehicle collides under a condition in which a position of the head restraint is not adjusted.

The head restraint position adjusting method may further comprise: detecting an estimated center position of the head in the height direction as the reference position based on, for example the detection signals; and adjusting a position of the head restraint relative to the seat with reference to the detected estimated center position of the head in the height direction.

The head restraint position adjusting method may further comprise: detecting the detection electrode having the detection signal with the highest output among the plurality of detection electrodes based on, for example, the detection signals; and adjusting a position of the head restraint relative to the seat so that the detected detection electrode having the detection signal with the highest output is located above a center position of the head restraint in the height direction.

### Effect of the Invention

According to the present invention, it is possible to provide a head restraint position adjusting device and a head restraint position adjusting method which appropriately and automatically adjust a position of the head restraint relative to the seat from a standstill condition with reference to the reference position of the head in the height direction, thereby adjusting a position of the head restraint highly precisely within a short time.

### BEST MODE FOR CARRYING OUT THE INVENTION

An explanation will be given of a preferred embodiment for a head restraint position adjusting device and a head restraint position adjusting method of the present invention in detail with reference to the accompanying drawings.

FIG. 1 is a schematic diagram showing an example of a seat in a vehicle provided with a head restraint position adjusting device according to a first embodiment of the present invention. FIG. 2 is an explanatory diagram showing an example arrangement of a part of the head restraint position adjusting device in a head restraint. FIG. 3 is a block diagram showing an example of a whole configuration of the head restraint position adjusting device.

FIG. 4 is a block diagram showing an example configuration of a capacitance detection circuit of the head restraint position adjusting device. FIG. 5 is an operation waveform chart showing an example of an operation waveform of a detection circuit of the head restraint position adjusting device. FIG. 6 is an explanatory diagram showing an example of an output of a detection electrode of the head restraint position adjusting device.

As shown in FIGS. 1 and 2, a head restraint position adjusting device 100 is provided in a seat 40 of a vehicle and the like, and comprises, for example, a capacitance sensor unit 10 arranged in a head restraint 43 of the seat 40, and a drive motor unit 30 arranged in a backrest 41 of the seat 40. According to the head restraint position adjusting device 100 of the embodiment, the capacitance sensor unit 10 and the drive motor unit 30 are electrically connected together by, for example, a harness 29.

The capacitance sensor unit 10 comprises plural detection electrodes 11 to 15 formed on one face of a board 19, and a detection circuit 20 formed on another face of the board 19, and detects a head 49 of a human body 48 sitting down the seat 40. That is, the capacitance sensor unit 10 detects a capacitance between the head 49 of the human body 48 and the head restraint 43 (more specifically, detection electrodes 11 to 15).

The board 19 comprises, for example, a flexible printed board, a rigid board, or a rigid-flexible board. The plural detection electrodes 11 to 15 are formed of copper, a copper alloy, or aluminum formed and patterned on the board 19 formed of an insulating body such as polyethylene terephthalate (PET), polyethylene naphthalate (PEN), polyimide (PI), polyamide (PA), or an epoxy resin.

The plural detection electrodes 11 to 15 are each formed in a rectangular strip having a long side in a width direction intersecting with the height direction of the head restraint 43 (width direction intersecting with the height direction along the front face of the head restraint 43) at the front face side of the head restraint 43, and are arranged side by side in a line in such a way that the loner sides of the respective detection electrodes 11 to 15 are line up along the height direction of the head restraint 43.

For example, electrode number 1 to 5 are allocated to the plural detection electrodes 11 to 15. There are five detection electrodes 11 to 15 in the embodiment, but for example, equal to five or greater detection electrodes can be provided by what corresponds to the number necessary to detect a reference position of the head 49 of the human body 48 sitting down the seat 40 in the height direction with the head restraint 43 being at a standstill.

The detection circuit 20 detects an estimated center position of the head 49 in the height direction as, for example, a reference position in the embodiment based on detection signals from the plural detection electrodes 11 to 15. As shown in FIG. 3, the detection circuit 20 comprises plural capacitance detection circuits 21 to 25 which are connected to the plural detection electrodes 11 to 15, respectively, one by one, and which outputs information indicating a capacitance detected by each detection electrode 11 to 15, and an arithmetic processing circuit 28 which is connected to the capacitance detection circuits 21 to 25, compares values of capacitance based on information output by individual capacitance detection circuits, calculates an estimated center position of the head 49 in the height direction, and outputs calculation result information to a motor drive circuit (not shown) of the drive motor unit 30.

The plural capacitance detection circuits 21 to 25 each generates a pulse signal having a duty ratio changing in accordance with a capacitance between each detection electrode 11 to 15 and the head 49, and outputs such a signal having undergone smoothing as a detection signal. The arithmetic processing circuit 28 comprises a CPU, a RAM, a ROM, and the like, compares values of capacitance based on detection signals output by the individual capacitance detection circuits 21 to 25, detects an estimated center position of the head 49 in the height direction, and outputs a control signal (drive information) as information on the basis of a calculation result to the drive motor unit 30 which changes a position of the head restraint 43.

As shown in FIG. 4, each capacitance detection circuit 21 (22 to 25) changes a duty ratio in accordance with a capacitance C, and comprises, for example, a trigger signal generating circuit 101 which outputs a trigger signal TG with a constant period, a timer circuit 102 which outputs a pulse signal Po having a duty ratio changing in accordance with a largeness of the capacitance C connected to an input terminal, and a low-pass filter (LPF) 103 which performs smoothing on the pulse signal Po.

The timer circuit 102 comprises, for example, two comparators 201, 202, an RS flip-flop circuit (hereinafter, “RS-FF”) 203 having a reset terminal R and a set terminal S into which outputs of the comparators 201, 202 are respectively input, a buffer 204 which outputs an output DIS of the RS-FF 203 to the LPF 103, and a transistor 205 which is turned on/off by the output DIS from the RS-FF 203.

The comparator 202 compares the trigger signal TG shown in FIG. 5 and output by the trigger signal generating circuit 101 with a prescribed threshold Vth2 divided by resistors R1, R2, and R3, and outputs a set pulse synchronized with the trigger signal TG. The set pulse sets an output Q of the RS-FF 203.

The output Q turns off the transistor 205 as the discharge signal DIS, and charges between the detection electrode 11 (12 to 15) and a ground at a speed defined by a time constant set by the capacitance C of each detection electrode 11 (12 to 15) and a resistor R4 connected between the input terminal and a power-supply line. Accordingly, a potential of an input signal Vin increases at a speed defined by the capacitance C.

If the input signal Vin becomes larger than a threshold Vth1 defined by the resistors R1, R2, and R3, an output of the comparator 201 is inverted, and an output of the RS-FF 203 is also inverted. As a result, the transistor 205 turns on, and a charge trapped in the detection electrode 11 (12 to 15) is discharged through the transistor 205.

Therefore, as shown in FIG. 5, the timer circuit 102 outputs the pulse signal Po which oscillates at a duty ratio based on the capacitance C between the detection electrode 11 (12 to 15) and the head 49 of the human body 48 which comes close thereto. The LPF 103 performs smoothing on this output, and outputs a direct-current detection signal Vout as shown in FIG. 5. Note that in FIG. 5, a waveform indicated by a solid line and a waveform indicated by a dotted line mean that the former has a larger capacitance than latter, and for example, the latter represents a condition in which an object comes close.

In the embodiment, the drive motor unit 30 comprises a motor drive circuit which controls a non-illustrated drive motor based on a control signal from the arithmetic processing circuit 28 that has calculated an estimated center position of the head 49 in the height direction based on the detection signal Vout from each capacitance detection circuit 21 to 25, and which changes a position of the head restraint 43 relative to the backrest 41 of the seat 40 with reference to the estimated center position of the head 49 in the height direction, and the drive motor which actually changes the position of the head restraint 43 under the control of the motor drive circuit.

In the first embodiment, the drive motor drives the head restraint 43 freely movable in the vertical direction (height direction) through a support axis 43a, but in addition, may drive the head restraint 43 freely movable right and left and back and forth which are directions intersecting with the vertical direction. Note that the estimated center position of the head 49 in the height direction which is the reference position is not always consistent with the center position of the head 49, so that the estimated center position is acquired as follow.

That is, according to the head restraint position adjusting device 100 having the foregoing configuration, for example, the capacitance C between each detection electrode 11 to 15 of the capacitance sensor unit 10 and the head 49 is detected in an initial condition (a condition in which the head restraint 43 is positioned at the most closest position to the backrest 41), and the detection circuits 20 detects and compares peaks of respective such outputs one another, thereby acquiring the estimated center position of the head 49 in the height direction.

According to the tests carried out by the applicant of the present invention, in this case, an output (V) of each detection electrode 11 to 15 (electrode number 1 to 5) is as shown in FIG. 6. An output of the detection electrode 13 having the electrode number 3 is highest beyond 0.15 V, and an output of the detection electrode 11 having the electrode number 1 is lowest under 0.05 V. Accordingly, in this example, the detection circuit 20 determines that a position corresponding to the detection electrode 13 is the estimated center position of the head 49 in the height direction, and performs position adjustment by causing the drive motor unit 30 and the like to conform the center position of the head restraint 43 to the estimated center position.

Therefore, the head restraint position adjusting device 100 of the first embodiment can acquire an estimated center position of the head 49 in the height direction without moving the head restraint 43 in a movable range between top and bottom from an initial condition, and can arrange the head restraint 43 at the best position relative to the head 49 through just one moving operation of the head restraint 43 regarding a position adjustment. Accordingly, it is possible to suppress any accident like cervical spine injury of the human body 48 when a vehicle collides under a condition in which a position of the head restraint 43 is not adjusted.

Note that the capacitance sensor unit 10 and the drive motor unit 30 in the head restraint position adjusting device 100 are electrically connected together via the harness 29 in the embodiment, but the drive motor unit 30 may be remotely-controlled via a wireless device or the like. Moreover, the drive motor unit 30 may be built together with the capacitance sensor unit 10, and may be arranged in the head restraint 43.

The detection circuit 20 may profile the shape of the head 49 using the arithmetic processing circuit 28, calculate an estimated center position from a profiling result, and move the head restraint 43 based on this calculation result, in addition to just moving the center position of the head restraint 43 to the estimated center position. Further, the detection circuit 20 may conform an arbitrary position of the head restraint 43 to the estimated center position based on, for example, profile information on the human body 48 (containing information on the shape of the head 49) or information on the shape of the head restraint 43 itself stored beforehand.

FIG. 7 is a block diagram showing another example of a whole configuration of the head restraint position adjusting device 100 of the first embodiment of the present invention. Elements duplicating with ones already explained will be denoted by the same reference numerals, explanations thereof will be omitted in some cases, and elements which do not particularly relate to the present invention will not be explained in some cases.

As shown in FIG. 7, the detection circuit 20 comprises a time-sharing circuit 26 connected to each of the detection electrodes 11 to 15, a capacitance detection circuit 27 which outputs information indicating a capacitance detected by the time-sharing circuit 26 through each detection electrode 11 to 15 in a different time, and an arithmetic processing circuit 28 which compares values of capacitance indicated by information output by the capacitance detection circuit 27, calculates an estimated center position or the like of the head 49 in the height direction, and outputs a calculation result to the motor drive circuit of the drive motor unit 30.

According to such a configuration of the detection circuit 20, it becomes possible to scan capacitances by individual detection electrodes 11 to 15 in turns through the time-sharing circuit 26, and to acquire the estimated center position of the head 49 in the height direction as a reference position based on a scanning result. Therefore, using the detection circuit 20 with such a configuration also makes it possible to adjust a position of the head restraint 43 highly precisely within a short time.

Next, an explanation will be given of a second embodiment of the present invention. FIG. 8 is an explanatory diagram showing an example arrangement of a part of a head restraint position adjusting device in a head restraint according to the second embodiment of the present invention. The head restraint position adjusting device 100 of the second embodiment has a similar configuration to that of the head restraint position adjusting device 100 of the first embodiment. That is, the head restraint position adjusting device 100 of the second embodiment comprises the capacitance sensor unit 10 and the drive motor unit 30.

As shown in FIG. 8, the detection electrodes 11 to 15 of the capacitance sensor unit 10 are each formed in a rectangular strip having a long side in a width direction intersecting with the height direction along the front face of the head restraint 43 at the front face side of the head restraint 43, and are arranged side by side in a line in such a way that the long sides of the respective detection electrodes 11 to 15 are line up along the height direction of the head restraint 43 across the entire area of the head restraint 43 in the height direction at an equal interval.

Like the first embodiment, electrode number 1 to 5 are allocated to the plural detection electrodes 11 to 15, and there are five detection electrodes in the second embodiment. Unlike the first embodiment, however, the detection electrodes are arranged by what corresponds to a fashion and a number that a detection electrode having a detected detection signal with the highest output is arranged above a center position P′ of the head restraint 43 in the height direction, and for example, equal to five or greater detection electrodes are provided.

The detection circuit 20 detects a detection electrode having a detection signal with the highest output among the detection electrodes 11 to 15 based on detection signals from respective plural detection electrodes 11 to 15. The detection circuit 20 has the same configuration as that explained with reference to FIG. 3, so that explanation thereof will be omitted.

However, the difference is that the arithmetic processing circuit 28 compares values of capacitance indicated by information output by the respective capacitance detection circuits 21 to 25, detects a detection electrode having the largest detected capacitance, and outputs drive information on the head restraint 43 to the motor drive circuit of the drive motor unit 30 in accordance with the detection result. The configuration of each capacitance detection circuit 21 (22 to 25) and the operation waveform thereof are same as those explained with reference to FIGS. 4 and 5, so that explanation thereof will be omitted.

The drive motor unit 30 comprises a motor drive circuit which controls a non-illustrated drive motor based on a control signal from the arithmetic processing circuit 28 that has detected a detection electrode (hereinafter, “corresponded detection electrode”) having a detection signal with the highest (largest) output among detection signals Vout from the capacitance detection circuits 21 to 25, and which causes a non-illustrated drive motor to change a position of the head restraint 43 relative to the backrest 41 of the seat 40 in such a way that the corresponded detection electrode positions above the center position P′ of the head restraint 43 in the height direction, and a drive motor like the first embodiment.

As shown in FIG. 8, the center position P′ of the head restraint 43 in the height direction represents a center part when the front part of the head restraint 43 is viewed from the front, but may be changed appropriately depending on the shape of the head restraint 43.

According to the head restraint position adjusting device 100 having the foregoing configuration, a capacitance C between each detection electrode 11 to 15 of the capacitance sensor unit 10 and the head 49 is detected in an initial condition like the first embodiment, and the detection circuit 20 detects and compares peaks of respective outputs one another, thereby detecting a corresponded detection electrode having the highest output. A position of the corresponded detection electrode is set to be a reference position, and position adjustment is carried out so that the reference position becomes an appropriate position of the head restraint 43 relative to the head 49 when the reference position is located above the center position P′ of the head rest 43 in the height direction.

An explanation will be given of a comparative example with respect to the head restraint position adjusting device 100 of the second embodiment. Note that an explanation will be given of an output when the detection electrodes 11 to 15 are arranged across the entire area of the head restraint 43 in the height direction at an equal interval. A center position P of the head 49 is set to be a center of a line connecting a tail of an eye and a center of an ear.

According to the tests carried out by the applicant of the present invention, as shown in FIG. 9(a), when a center position P′ of the head restraint 43 in the height direction is located above the center position P of the head 49, as shown in FIG. 9(b), outputs (V) of the individual detection electrodes 11 to 15 (electrode number 1 to 5) became as follow.

That is, an output of the detection electrode 13 having the electrode number 3 exceeds 0.75 V and is highest, and outputs of the detection electrodes 11, 15 having the electrode number 1, 5, respectively, are 0.25 V or so and are lowest. In this case, because the center position P of the head 49 is not coincident with the center position P′ of the head restraint 43 in the horizontal direction, it is difficult to say that the position of the head restraint 43 is an appropriate position.

Conversely, as shown in FIG. 10(a), when the center position P of the head 49 and the center position P′ of the head restraint 43 in the height direction are coincident with each other, in the horizontal direction, outputs (V) of the individual detection electrodes 11 to 15 (electrode number 1 to 5) became as shown in FIG. 10(b).

An output of the detection electrode 14 having the electrode number 4 exceeds 0.75 V and is highest, and, an output of the detection electrode 11 having the electrode number 1 is below 0.25 V and is lowest. At this time, because the center positions P, P′ are consistent in the horizontal direction, it is possible to presume that the head restraint 43 is at an appropriate position.

The detection circuit 20 determines that a position of the head restraint 43 relative to the seat 40 (backrest 41) in this condition is appropriate, and outputs a control signal to the drive motor 30 for a position adjustment.

Therefore, the head restraint position adjusting device 100 of the second embodiment can set the center position P′ of the head restraint 43 in the height direction relative to the center position P of the head 49 without performing scanning by moving the head restraint 43 in a movable range from top to bottom from an initial condition for example. Accordingly, it is possible to arrange the head restraint 43 at the best position relative to the head 49 by just one moving operation of the head restraint 43 relating to a position adjustment in one direction.

Therefore, it becomes possible to adjust a position of the head restraint 43 highly precisely within a short time. Moreover, because the head restraint 43 is automatically moved to the best position, it is possible to suppress any accident like cervical spine injury of the human body 48 when a vehicle collides under a condition in which a position of the head restraint 43 is not adjusted.

The detection circuit 20 may profile the shape of the head 49 of a driver/passenger (human body) of a vehicle using the arithmetic processing circuit 28, store an appropriate position based on the profiling result beforehand, read out the stored profile when position adjustment is started, and move the head restraint 43 in accordance with each driver/passenger, in addition to merely detecting a detection electrode having a detection electrode with the highest output and moving the head restraint 43.

Furthermore, the detection circuit 20 may move an arbitrary position of the head restraint 43 in the height direction including the center position P′ to a position coincident with the center position P of the head 49 in the horizontal direction on the basis of profile information (including information on the shape of the head 49) on the human body 48 preset at the time of shipping of the head restraint position adjusting device 100 from a factory, information on the shape (size, surface contour and the like) of the head restraint 43, and the like.

Regarding a structure that the detection circuit 20 has one time-sharing circuit 26, a capacitance detection circuit 27, and an arithmetic processing circuit 28, it is same as one explained in the first embodiment with reference to FIG. 7, and there is merely a slight difference that values of capacitance are compared to detect a detection electrode having a detection electrode with the highest output, and drive information based on the detection result is output, so that detailed explanation will be omitted.

FIG. 11 is an explanatory diagram showing another example arrangement of a part of the head rest position adjusting device of the second embodiment in a head restraint, and FIG. 12 is an explanatory diagram showing an example of an output of the detection electrode of the head restraint position adjusting device. The head restraint position adjusting device of this example has the same configuration as the foregoing configuration except that arrangement of each detection electrode 11 to 15 in the capacitance sensor unit 10 differs from the capacitance sensor unit 10 of the foregoing example, so that explanation for the same configuration will be omitted.

As shown in FIG. 11, individual detection electrodes 11 to 15 are arranged in the height direction of the head restraint 43 at an equal interval, and a detection electrode group 10a comprised of the detection electrodes 11 to 15 is so arranged as to be shifted as a whole in the height direction relative to, for example, the center position P′ of the head restraint 43 in the height direction so that a detection electrode (e.g., detection electrode 13) arranged in the vicinity of the center of the detection electrode group 10a in the height direction is detected by the detection circuit 20 as a corresponded detection electrode having a detection signal with the highest output.

Accordingly, as shown in FIG. 12(a), for example, when the center position P of the head 49 is coincident with the center position P′ of the head restraint 43 in the height direction, an output (V) of each detection electrode 11 to 15 (electrode number 1 to 5) becomes as shown in FIG. 12(b).

That is, an output of the detection electrode 13 having the electrode number 3 exceeds 0.75 V and is highest, and outputs of the detection electrodes 11, 15 having the electrode number 1, 5, respectively, are 0.25 V or so and are lowest. At this time, because the center positions P, P′ are coincident with each other in the horizontal direction, like the foregoing example in the second embodiment, it is possible to presume that the head restraint 43 is at an appropriate position, and the detection circuit 20 determines that a position of the head restraint 43 relative to the seat 40 (backrest 41) in this condition is appropriate, and outputs a control signal to the drive motor 30 for a position adjustment.

As explained above, according to the head restraint position adjusting device of the second embodiment, it is possible to set the center position P′ in the height direction relative to the center position P of the head 49 without performing scanning by moving the head restraint 43 in a movable range from top to bottom from an initial condition for example, and to arrange the head restraint 43 at the best position relative to the head 49 by just one moving operation of the head restraint 43 relating to a position adjustment in one direction, so that it becomes possible to adjust a position of the head restraint 43 highly precisely within a short time. Moreover, because the head restraint 43 is automatically moved to the best position, it is possible to suppress any accident like cervical spine injury of the human body 48 when a vehicle collides under a condition in which a position of the head restraint 43 is not adjusted.

Although the explanation has been given of the case where the head restraint position adjusting device is applied to the head restraint 43 of the seat 40 of a vehicle in the first and second embodiments, the head restraint position adjusting device 100 can be applied to, for example, a set for an amusement attraction and a seat for theatrical appreciation which can change a position of a head restraint.

### INDUSTRIAL APPLICABILITY

The present invention is useful for carrying out position adjustment highly precisely within a short time by a device for a seat of a vehicle or the like which adjusts a position of a head restraint

### BRIEF DESCRIPTION OF DRAWINGS

FIG. 1 is a schematic diagram showing an example of a seat in a vehicle provided with a head restraint position adjusting device according to a first embodiment of the present invention;

FIG. 2 is an explanatory diagram showing an example arrangement of a part of the head restraint position adjusting device in a head restraint;

FIG. 3 is a block diagram showing an example of a whole configuration of the head restraint position adjusting device;

FIG. 4 is a block diagram showing an example configuration of a capacitance detection circuit of the head restraint position adjusting device;

FIG. 5 is an operation waveform chart showing an example of an operation waveform of a detection circuit of the head restraint position adjusting device;

FIG. 6 is an explanatory diagram showing an example of an output of a detection electrode of the head restraint position adjusting device;

FIG. 7 is a block diagram showing another example of a whole configuration of the head restraint position adjusting device according to the first embodiment of the present invention;

FIG. 8 is an explanatory diagram showing an example arrangement of a part of a head restraint position adjusting device in a head restraint according to a second embodiment of the present invention;

FIG. 9 is an explanatory diagram showing a comparative example of an output of a detection electrode of the head restraint position adjusting device;

FIG. 10 is an explanatory diagram showing an example of an output of the detection electrode of the head restraint position adjusting device;

FIG. 11 is an explanatory diagram showing another example arrangement of a part of the head rest position adjusting device in a head restraint;

FIG. 12 is an explanatory diagram showing an example of an output of the detection electrode of the head restraint position adjusting device; and

FIG. 13 is a diagram showing a detection result of a sensor output in a test carried out by the applicant of the present invention.

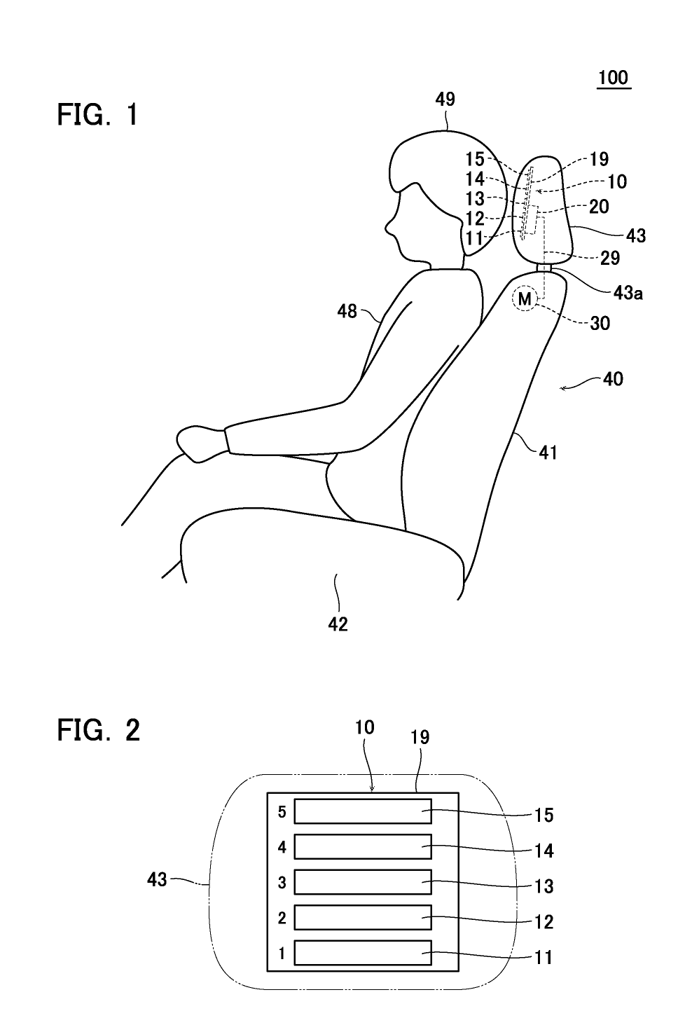

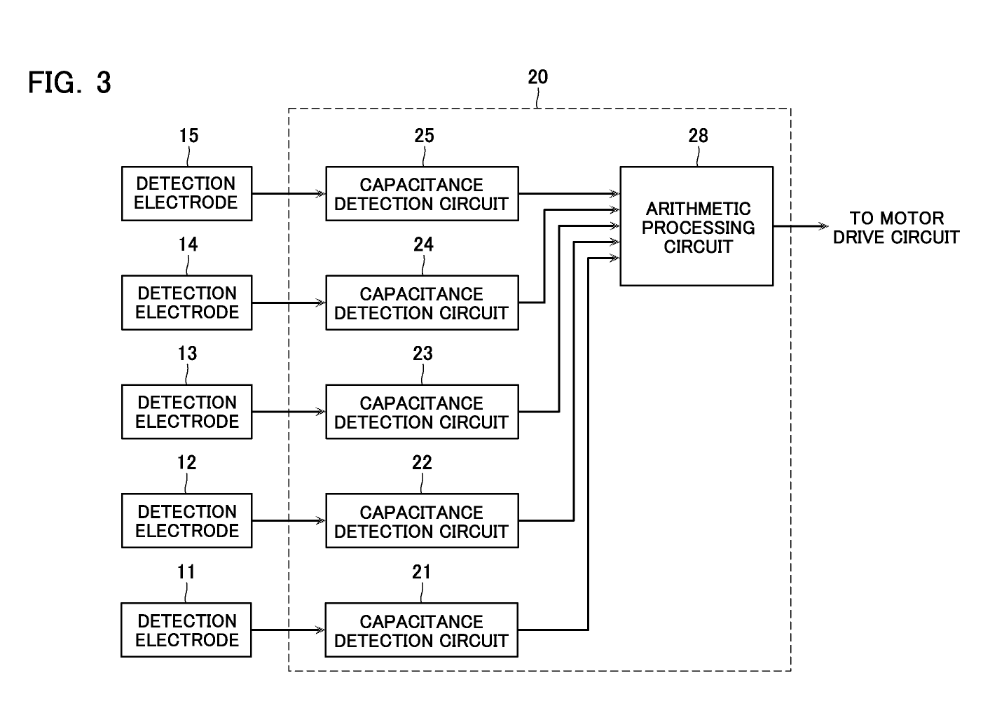

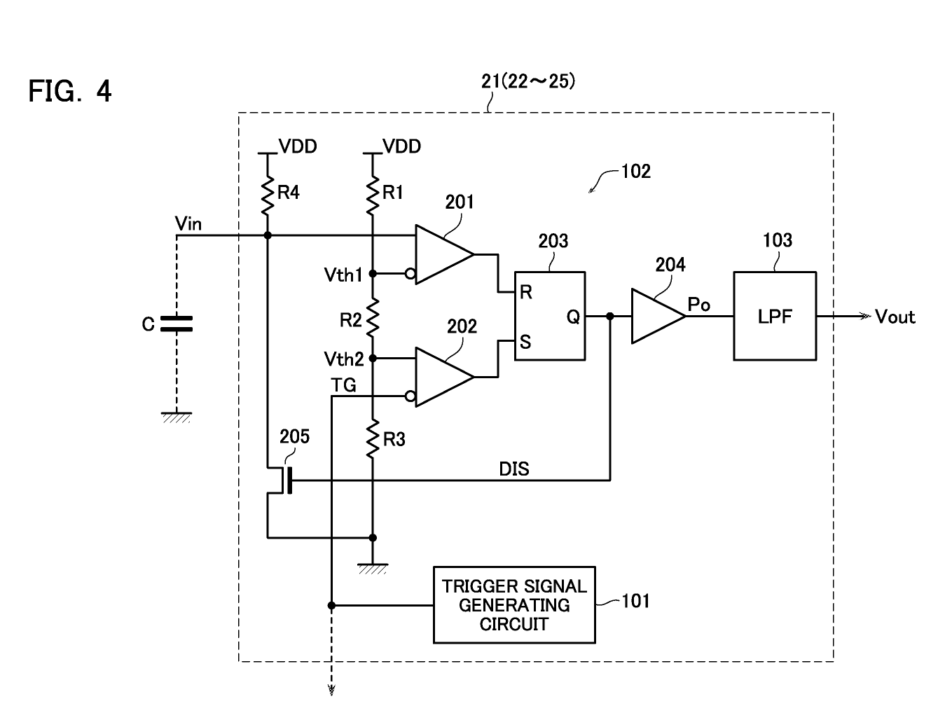

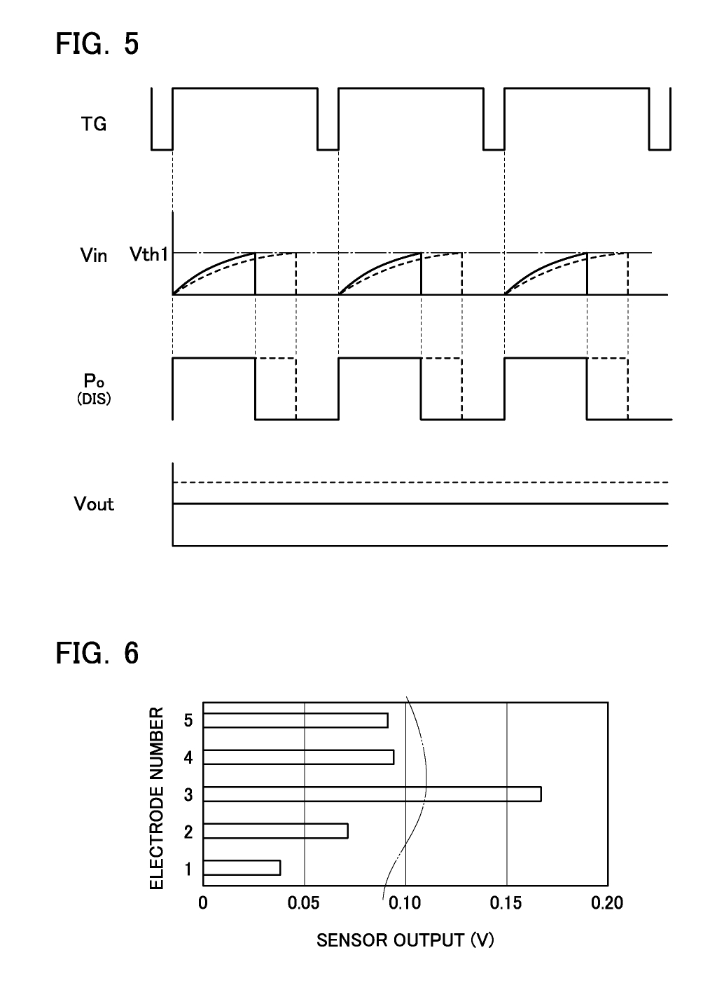

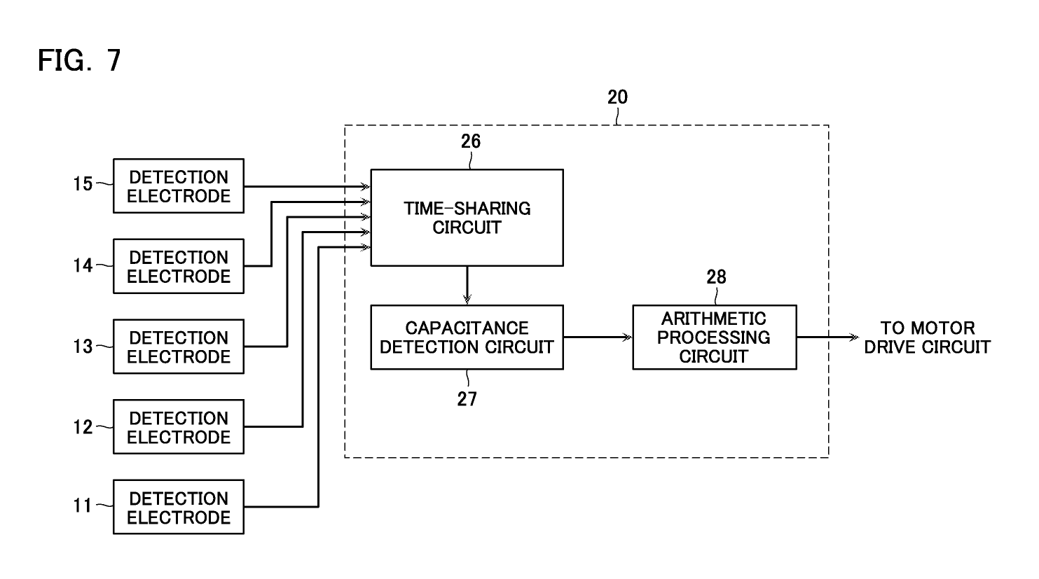

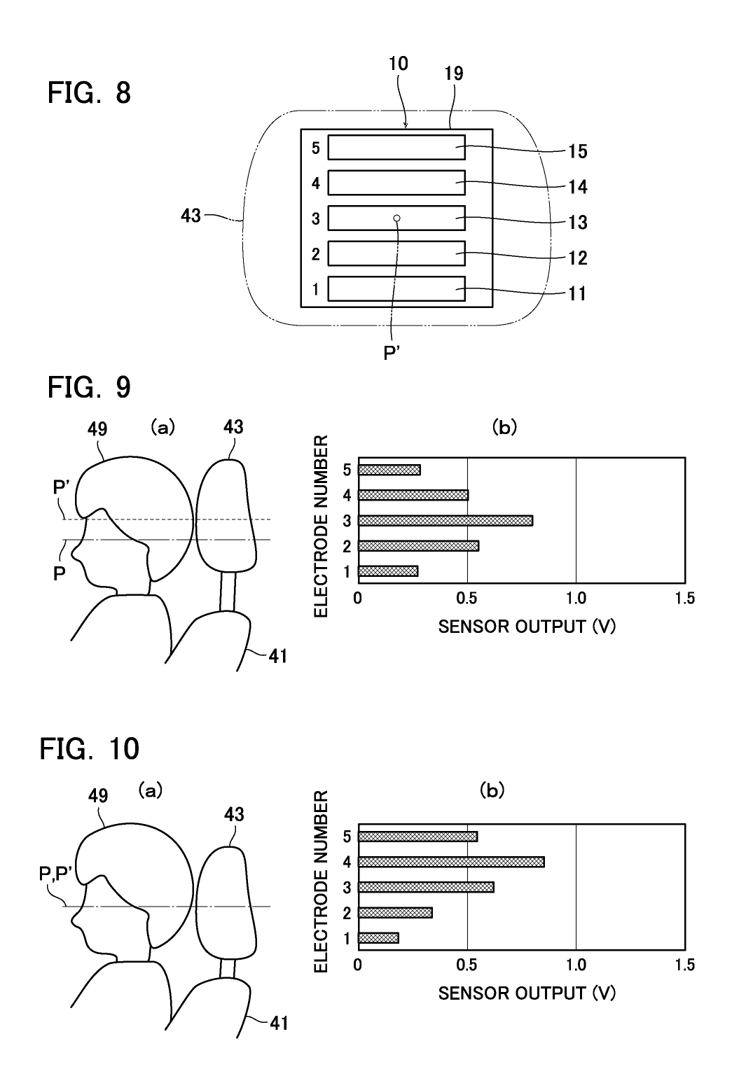

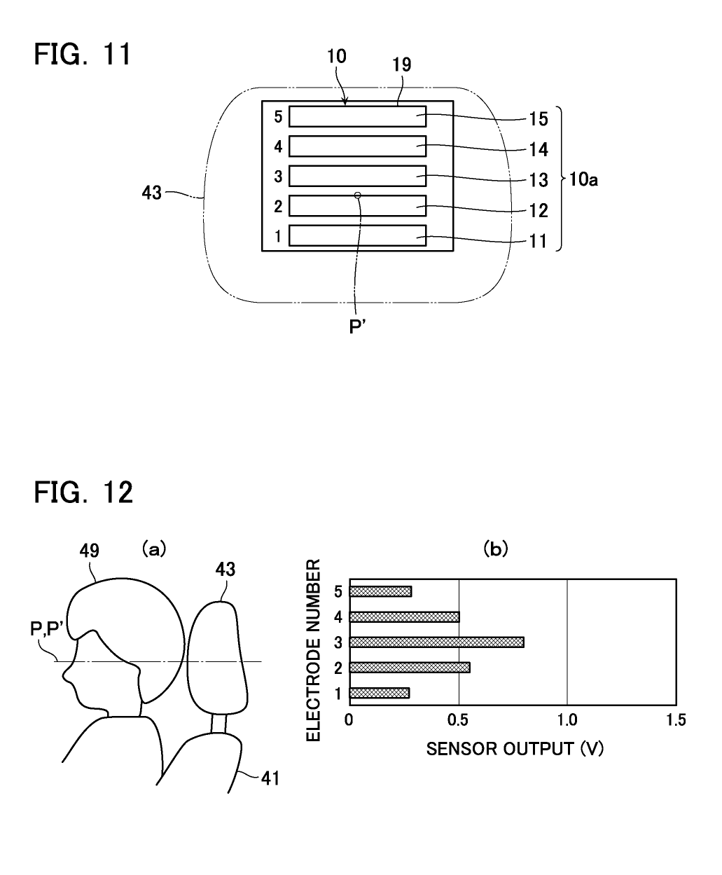

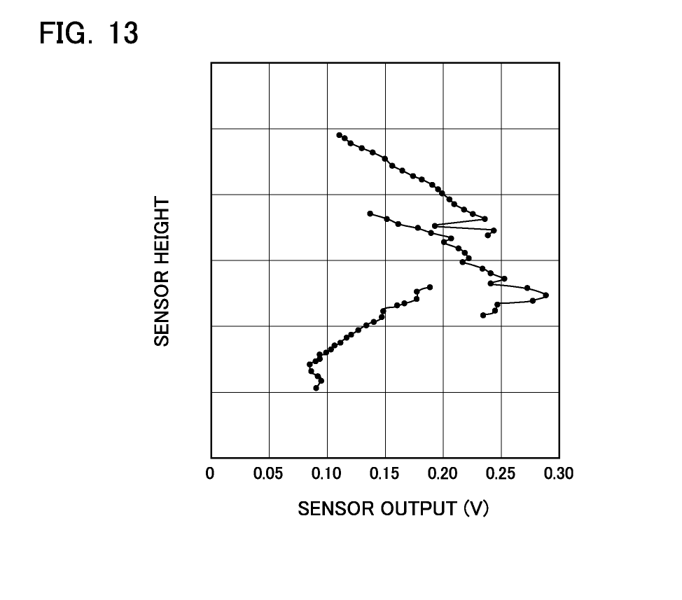

### DESCRIPTION OF REFERENCE NUMERALS

10 Capacitance sensor unit

10a Detection electrode group

11 to 15 Detection electrode

19 Board

20 Detection circuit

21 to 25, 27 Capacitance detection circuit

26 Time-sharing circuit

28 Arithmetic processing circuit

29 Harness

30 Drive motor unit

40 Seat

41 Backrest

42 Seating portion

43 Head restraint

43a Support axis

48 Human body

49 Head

1-17. (canceled)

18. A head restraint position adjusting device comprising:
a plurality of detection electrodes arranged side by side in a line along a height direction of a head restraint attached to a seat of a vehicle, and each configured to output information as a detection signal;
a detection circuit configured to detect a reference position of the head in the height direction based on the detection signals from the plurality of respective detection electrodes; and
position adjusting means for adjusting a position of the head restraint relative to the seat with reference to the detected reference position of the head in the height direction in accordance with a detection result of the detection circuit,
and the plurality of detection electrodes being provided by what corresponds to a number required for detecting the reference position of the head in the height direction with the head restraint being at a standstill,
characterized by the information output by each detection electrode indicating a capacitance and the detection circuit being configured to detect capacitances between a head of a human body sitting down in the seat and each of the detection electrodes based on each detection signal.

19. The head restraint position adjusting device according to claim 18, wherein the detection circuit detects an estimated center position of the head in the height direction as the reference position, and the position adjusting means adjusts a position of the head restraint relative to the seat with reference to the estimated center position of the head in the height direction.

20. The head restraint position adjusting device according to claim 18, wherein the detection circuit detects, as the reference position, the detection electrode having a detection signal with the highest output among the plurality of detection electrodes, and the position adjusting means adjusts a position of the head restraint relative to the seat so that the detection electrode having the detection signal with the highest output and detected by the detection circuit is located above a center position of the head restraint in the height direction.

21. The head restraint position adjusting device according to claim 18, wherein the plurality of detection electrodes are each formed in a rectangular strip having a long side arranged in a width direction intersecting with the height direction of the head restraint at a front face side of the head restraint.

22. The head restraint position adjusting device according to claim 18, wherein the plurality of detection electrodes are arranged across the entire area of the head restraint in the height direction at an equal interval.

23. The head restraint position adjusting device according to claim 18, wherein the plurality of detection electrodes are arranged in the height direction of the head restraint at an equal interval, and a detection electrode group comprised of the plurality of detection electrodes is so arranged as to be shifted as a whole in the height direction so that the detection electrode arranged in the vicinity of a center of the detection electrode group in the height direction is detected by the detection circuit as the detection electrode having a detection signal with the highest output.

24. The head restraint position adjusting device according to claim 18, wherein the plurality of detection electrodes are each formed in a rectangular strip having a long side in a width direction intersecting with the height direction of the head restraint along a front face thereof, and are arranged on the front face side of the head restraint.

25. The head restraint position adjusting device according to claim 18, wherein at least five detection electrodes are provided on a front face side of the head restraint.

26. The head restraint position adjusting device according to claim 18, wherein the detection circuit comprises:
a plurality of capacitance detection circuits connected to the plurality of respective detection electrodes one by one, and each configured to output information indicating a capacitance detected by each detection electrode; and an arithmetic processing circuit configured to compare values of capacitance based on plural pieces of information from the plurality of respective capacitance detection circuits, calculate the reference position or detect the detection electrode having the largest detected capacitance, and output drive information for the head restraint to the position adjusting means in accordance with calculation result information or a detection result.

27. The head restraint position adjusting device according to claim 18, wherein the detection circuit comprises:
a time-sharing circuit connected to the plurality of detection electrodes; a capacitance detection circuit configured to output information indicating a capacitance detected by each of the plurality of detection electrodes through the time-sharing circuit in a different time; and an arithmetic processing circuit configured to compare values of capacitance based on plural pieces of information from the capacitance detection circuit, calculate the reference position or detect the detection electrode having the largest detected capacitance, and output drive information for the head restraint to the position adjusting means in accordance with calculation result information or a detection result.

28. A head restraint position adjusting method comprising: detecting a capacitance between a head of a human body sitting down in a seat of a vehicle and a head restraint attached to the seat through a plurality of detection electrodes arranged side by side in a line in the head restraint along a height direction of the head restraint, the plurality of detection electrodes being provided by what corresponds to a number required for detecting a reference position of the head of the human body sitting down the seat in the height direction with the head restraint being at a standstill; detecting the reference position of the head in the height direction based on detection signals each indicating a detected capacitance and output by each of the plurality of detection electrodes; and adjusting a position of the head restraint relative to the seat with reference to the detected reference position of the head in the height direction.

29. The head restraint position adjusting method according to claim 28, further comprising: detecting an estimated center position of the head in the height direction as the reference position based on the detection signals; and adjusting a position of the head restraint relative to the seat with reference to the detected estimated center position of the head in the height direction.

30. The head restraint position adjusting method according to claim 28, further comprising: detecting the detection electrode having the detection signal with the highest output among the plurality of detection electrodes based on the detection signals; and adjusting a position of the head restraint relative to the seat so that the detected detection electrode having the detection signal with the highest output is located above a center position of the head restraint in the height direction.

31. The head restraint position adjusting method according to claim 28, wherein the plurality of detection electrodes are each formed in a rectangular strip having a long side arranged in a width direction intersecting with the height direction of the head restraint at a front face side of the head restraint.

32. The head restraint position adjusting method according to claim 28, wherein the plurality of detection electrodes are arranged across an entire area of the head restraint in the height direction.

33. The head restraint position adjusting method according to claim 28, wherein the plurality of detection electrodes are arranged in the height direction of the head restraint at an equal interval, and a detection electrode group comprised of the plurality of detection electrodes is so arranged as to be shifted as a whole in the height direction so that the detection electrode arranged in the vicinity of a center of the detection electrode group in the height direction is detected by the detection circuit as the detection electrode having a detection signal with the highest output.

34. The head restraint position adjusting method according to claim 28, wherein the plurality of detection electrodes are each formed in a rectangular strip having a long side in a width direction intersecting with the height direction of the head restraint along a front face thereof, and are arranged on the front face side of the head restraint.

35. A head restraint position adjusting device comprising:
a plurality of detection electrodes arranged side by side in a line along a height direction of a head restraint attached to a seat of a vehicle, and each configured to detect a capacitance between a head of a human body sitting down the seat and the head restraint;
a detection circuit configured to compare detection signals from the plurality of respective detection electrodes with the head restraint being a standstill at an initial position, detect a maximum value of said detection signals, and calculate a position corresponding to the detection electrode detecting the maximum value as an estimated center position of the head in the height direction; and
position adjusting means for adjusting the head restraint such that the reference position of the head restraint is aligned with the estimated center position of the head in the height direction,
wherein the plurality of detection electrodes are provided by what corresponds to a number required for detecting the estimated center position of the head in the height direction in a stationary state at the initial position.

36. The head restraint position adjusting device according to claim 35, wherein the plurality of detection electrodes are each formed in a rectangular strip having a long side arranged in a width direction intersecting with the height direction of the head restraint at a front face side of the head restraint.

37. The head restraint position adjusting device according to claim 35, wherein at least five detection electrodes are provided on a front face side of the head restraint.
